(19) United States
(12) Patent Application Publication
(10) Pub. No.: US 2011/0114584 A1
(43) Pub. Date: May 19, 2011

(54) SADDLE HOLDER

(76) Inventors: Bradley Heath Shirey, Rushville, OH (US); John Milton Elliott, Roseville, OH (US)

(21) Appl. No.: 12/948,823

(22) Filed: Nov. 18, 2010

Related U.S. Application Data
(60) Provisional application No. 61/262,267, filed on Nov. 18, 2009.

(51) Int. Cl. B68C 1/00

(52) U.S. Cl. 211/85.11

(57) ABSTRACT

A lightweight, portable saddle holder that takes up a minimal amount of space when not in use. The saddle holder includes a horizontally-oriented, U-shaped saddle horn retainer that defines a saddle horn pass-through. A fulcrum bracket extends down and forward from the bottom of the saddle horn retainer, below the saddle horn pass through. The saddle holder can be mounted to a support structure by hooking a pair of mounting arms that project from a rear of the saddle holder over a top edge of the support structure. The horn of a saddle is inserted upwardly, through the saddle horn pass-through, and the swell of the saddle is brought to rest on the fulcrum bracket. The saddle thereby acts as a lever atop the fulcrum bracket, with the horn of the saddle held by the saddle horn retainer, thus preventing the saddle from tipping forward off of the fulcrum bracket.

### CROSS-REFERENCES TO RELATED APPLICATIONS

This application claims the benefit of U.S. Provisional Application No. 61/262,267 filed Nov. 18, 2009.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

This invention is generally directed to the field of horse saddles and saddle holders, and is more particularly directed to a lightweight, highly-portable, front-loading saddle holder.

Traditional saddle holders typically employ an elongated rack or shelf member that extends horizontally from a support structure, such as a wall or a stall rail, to which the saddle holder is permanently or temporarily mounted. To use such a saddle holder, the seat portion of a conventional saddle is mounted atop the rack of the saddle holder with the stirrups of the saddle hanging over the sides of the rack. The rack is generally longer than the saddle mounted thereon for providing the saddle with stability and for mitigating the risk of the saddle sliding off the end of the rack.

A problem commonly associated with traditional saddle holders of the type described above is that the elongated rack of such a holder significantly protrudes from the structure to which the saddle holder is mounted, thereby creating an inconvenient obstruction when the holder is not in use. For example, it is common for a passerby who fails to see an empty saddle holder and/or who does not have a sufficient amount of room to walk around the protruding rack of a saddle holder to accidentally collide with the rack and sometimes knock the saddle holder off of its mounting. Another problem associated with traditional saddle holders is that they tend to be relatively heavy and cumbersome and are therefore difficult to transport. Due to the inconveniences associated with traditional saddle holders, it is not uncommon for saddle owners to forgo the use of such holders altogether in favor of simply placing their saddles on the ground or atop bales of hay when not in use. Given that saddles can cost many hundreds, and sometimes even thousands of dollars, such alternatives are often highly undesirable.

In view of the foregoing, it is desirable to provide a portable saddle holder that is relatively small, lightweight, and that does not create a significant obstruction when not in use.

### BRIEF SUMMARY OF THE INVENTION

In accordance with the present invention, there is provided a lightweight, front-loading saddle holder that can be conveniently mounted to a variety of support structures. The saddle holder includes a horizontally-oriented (when oriented in an operable position), U-shaped saddle horn retainer that defines a saddle horn pass-through for accepting the horn of a conventional saddle in a vertical orientation. A curved fulcrum bracket extends down and forward from the bottom of the saddle horn retainer, below the saddle horn pass-through. Two mounting arms preferably extend downwardly from the rear of the saddle horn retainer, and at least one stop bracket extends rearwardly from behind the fulcrum bracket, thus defining a gap between the stop bracket and the mounting arms. An L-shaped adjustment bracket is slidably mounted to the stop bracket for allowing the adjustment bracket to be moved horizontally between a forward position, wherein a rear edge of the adjustment bracket does not extend beyond a rear terminus of the stop bracket, and a rear position, wherein the rear edge of the adjustment bracket does extend beyond a rear terminus of the stop bracket.

To mount the saddle holder to a support structure, such as a stall rail, the mounting arms are hooked over a top edge of the structure with the top edge fitting into the gap between the stop bracket and the mounting arms. The adjustment bracket is then slid rearwardly until it engages the support structure, thus firmly gripping the structure between the adjustment bracket and the mounting arms and securing the saddle holder against excessive tilting or wobbling upon the support structure.

To mount a saddle on the saddle holder, the horn of the saddle is inserted through the bottom of the saddle horn pass-through and the swell of the saddle is brought to rest on to top of the fulcrum bracket, with the bracket extending between the swell and seat of the saddle. The swell thus acts as a lever atop the fulcrum bracket, with the force of gravity urging the saddle to tilt forward off of the saddle holder, and with the inner forward edge of the saddle horn retainer restricting the forward movement of the saddle horn and preventing the saddle from tipping forward.

A bridle hook preferably extends from a bottom of the adjustment plate for allowing a bridle and reigns to be hung thereon.

Alternative embodiments of the saddle holder are contemplated wherein the saddle holder can be permanently mounted to a support structure, such as with conventional fasteners or adhesives.

The saddle holder is considerably smaller, lighter, and less obtrusive than traditional saddle holders because it does not have an elongated rack or shelf portion for fully supporting the entire length of a saddle thereon. The saddle holder can therefore be transported and used more easily and conveniently than traditional saddle holders.

### BRIEF DESCRIPTION OF THE SEVERAL VIEWS OF THE DRAWINGS

FIG. 1 is a perspective view illustrating the preferred embodiment of the present invention.

FIG. 2 is a perspective view in detail of the preferred embodiment of the present invention shown in FIG. 1 with a horse saddle mounted thereon.

FIG. 3 is a perspective view of the preferred embodiment of the present invention shown in FIG. 1 with a horse saddle mounted thereon.

FIG. 4 is a perspective view of an alternative embodiment of the present invention shown in FIG. 1.

FIG. 5 is a perspective view of a second alternative embodiment of the present invention shown in FIG. 1.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

This application claims the benefit of U.S. Provisional Application No. 61/262,267 which is herein incorporated by reference.

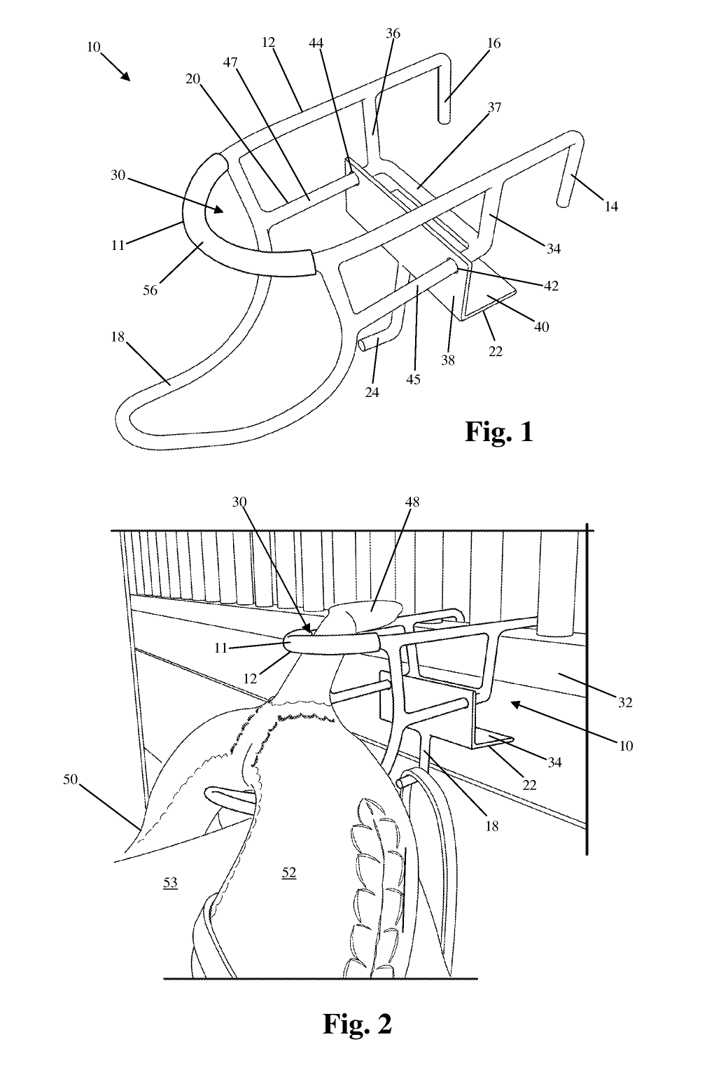

Referring to FIGS. 1-3, an improved saddle holder, indicated generally at 10, for holding various types of saddles is shown. The saddle holder 10 includes a saddle horn retainer 12, two mounting arms 14 and 16, a fulcrum bracket 18, a stop bracket 20, an adjustment bracket 22, and a bridle hook 24. The entire saddle holder 10 is preferably fabricated from stainless steel unless otherwise noted below, although it is contemplated that some or all of the components of the saddle holder 10 can alternatively be fabricated from any other suitably rigid and preferably lightweight material, including, but not limited to various types of metals, woods, plastics, composites, or any combination thereof.

For the sake of convenience and clarity, terms such as “top,” “bottom,” “up,” “down,” “front,” “rear,” “vertical” and “horizontal” will be used herein to describe the relative placement and orientation of the various components of the saddle holder 10, all with respect to the geometry and orientation of the holder as it appears in FIG. 2. Said terminology will include the words specifically mentioned, derivatives thereof, and words of similar import.

Referring to FIG. 1, the saddle horn retainer 12 of the saddle holder 10 is a generally U-shaped, horizontally-oriented member that has curved, laterally-extending front edge 11 and that defines a saddle horn pass-through 30 that is wider and longer than the outer dimensions of most conventional saddle horns. It is contemplated that the saddle horn retainer 12 can have a variety of shapes other than a U-shape, such as a rectangular, circular or triangular shape, as long as the saddle horn retainer 12 has a laterally-extending front edge and defines a pass-through that is large enough for allowing the horn of a conventional saddle to extend therethrough.

The mounting arms 14 and 16 of the saddle holder 10 extend perpendicularly-downwardly from, and are preferably integral with, the rear termini of the of the saddle horn retainer 12. The mounting arms 14 and 16 are preferably 2 inches long, although it is contemplated that the mounting arms 14 and 16 can be made shorter or longer. It is further contemplated that the mounting arms 14 and 16 can be covered with textured rubber or other high-friction materials for enhancing the grip of the mounting arms 14 and 16 when they engage another structure, such as a stall rail (as will be described in greater detail below).

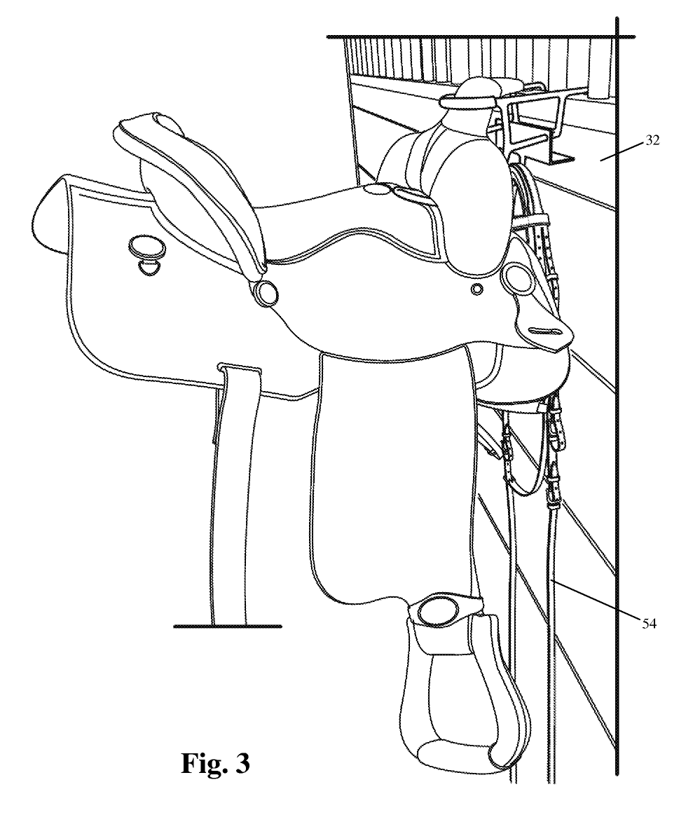

The fulcrum bracket 18 extends downwardly from the saddle horn retainer 12, below the saddle horn pass-through 30 and forward, away from a support structure, such as the stall rail 32 shown in FIGS. 2 and 3, to which the saddle holder 10 is mounted. The fulcrum bracket 18 preferably curves upwardly as it extends forward for accommodating the rounded contour of the forward swell of a conventional saddle that is brought to rest thereon (as described in greater detail below). The front edge of the fulcrum bracket 18 preferably projects forward beyond the front edge 11 of the saddle horn retainer 12.

The U-shaped stop bracket 20 extends horizontally from the rear of the fulcrum bracket 18, below the saddle horn retainer 12, toward the mounting arms 14 and 16. A pair of vertically-oriented support arms 34 and 36 preferably connect the rear leg 37 of the stop bracket 20 to the saddle horn retainer 12 for enhancing the strength and rigidity of the saddle holder 10, although it is contemplated that the support arms 34 and 36 can be omitted. The rear leg 37 of the stop bracket 20 is preferably positioned slightly below the lower termini of the mounting arms 14 and 16. The horizontal distance between the rear edge of the stop bracket 20 and the mounting arms 14 and 16 is preferably at least as great as the width of a conventional stall rail, and is more specifically in a preferred range of about 1 inch to about 5 inches.

The adjustment bracket 22 of the saddle holder 10 is preferably formed of a segment of angle iron having intersecting first and second walls 38 and 40. Two laterally-spaced apertures 42 and 44 are formed through the vertically-oriented first wall 38 of the adjustment bracket 22. The horizontally-oriented legs 45 and 47 of the stop bracket 20, which have outer dimensions that are slightly smaller than the dimensions of the apertures 42 and 44, extend through the apertures 42 and 44. The first wall 38 of the adjustment bracket 22 can thus be slid horizontally along the legs 45 and 47 of the stop bracket 20, between the fulcrum bracket 18 and the rear leg 37 of the stop bracket 20.

The second wall 40 of the adjustment bracket 22 extends perpendicularly rearward from the bottom edge of the first wall 38. When the adjustment bracket 22 is moved horizontally along the legs of the stop bracket 20, the second wall 40 is moved between a forward position, wherein the rear edge of the second wall 40 does not extend beyond the rear leg 37 of the stop bracket 20, and a rearward position, wherein the rear edge of the second wall 40 does extend beyond the rear leg 37 of the stop bracket 20. The significance of this adjustability will be described below.

The bridle hook 24 is an L-shaped member that extends down and forward from the bottom of the adjustment bracket 22. It is contemplated that the bridle hook 24 can be of any size and shape that is suitable for hanging an elongated, flexible item thereon or therethrough, such as a curved hook or a loop. It is further contemplated that one or more additional bridle hooks can be mounted to the adjustment bracket 22, or that the bridle hook 24 can be entirely omitted.

To use the saddle holder 10, it is preferable that the adjustment bracket 22 initially be moved to its forward position along the horizontally-oriented legs 45 and 47 of the stop bracket 20. The saddle holder 10 is then mounted to a support structure, such as the stall rail 32, by lowering the saddle holder 10 over a top edge of the rail 32 with the rail 32 extending upwardly into the gap between the rear leg 37 of the stop bracket 20 and the mounting arms 14 and 16. After the saddle holder 10 is brought to rest on the stall rail 32, the adjustment bracket 22 is slid backward along the legs of the stop bracket 20 until the rear edge of the second wall 40 of the adjustment bracket 22 engages the stall rail 32, thereby gripping the stall rail 32 between the adjustment bracket 22 and the mounting arms 14 and 16 and securing the orientation of the saddle holder 10 relative to the stall rail 32, thus mitigating the risk of the saddle holder 10 falling or being knocked off of the rail 32. An alternative embodiment of the saddle holder 10 is contemplated wherein the adjustment bracket 22 is omitted and wherein the stop bracket 20 is itself slidably adjustable between a horizontally-forward position and a horizontally-rearward position for adjustably gripping the top edge of a support structure in the manner of the adjustment bracket 22 described above.

Next, referring to FIGS. 2 and 3, the horn 48 of a saddle 50 is inserted through the bottom of the saddle horn pass-through 30, and the swell 52 of the saddle 50 is brought to rest on top of the fulcrum bracket 18 with the fulcrum bracket 18 extending between the swell 52 and the seat 53 of the saddle 50. Positioned thusly, the swell 52 acts as a lever, with the force of gravity on the forward-projecting end of the saddle 50 and the fulcrum bracket 18 of the saddle holder 10 cooperating to hold the saddle horn 48 in firm engagement with the inner front edge 11 of the saddle horn retainer 12 and to hold the swell 52 of the saddle 50 in firm engagement with the top and rear inner edges of the fulcrum bracket 18. More generally, as the force of gravity urges the saddle 50 to tip forward, off of the fulcrum bracket 18, the saddle horn retainer 12 prevents forward movement of the saddle horn 48 and thereby secures the saddle 50 against such tipping. The saddle 50 is thus securely suspended adjacent the stall rail 32. Lastly, a bridle 54 and reigns (not shown) can be hung from the bridle hook 24 as best shown in FIG. 3.

It is contemplated that the saddle holder 10 can be used to hold virtually any size and type of saddle, ranging from conventional full-size saddles to small pony saddles. It is preferred that certain portions of the saddle holder 10 that engage a saddle being held therewith, such as the front edge 11 of the saddle horn retainer 12, be formed of, or coated with, a relatively soft and resilient material for mitigating the possibility of damaging the saddle through chaffing or scratching. For example, the saddle horn retainer 12 can be covered with a soft plastic sheathing 56 as best shown in FIG. 1. Alternatively, portions of the saddle horn retainer 12 can be covered or coated with materials such as rubber, foam padding, or leather.

When the saddle 50 is removed from the saddle holder 10, the saddle holder 10 projects only about 11 inches from the stall rail 32 and is therefore minimally obtrusive compared to traditional saddle holders that commonly project over 2 feet from a support structure to which they are mounted. The risk of a passerby accidentally colliding with the saddle holder 10 is thereby mitigated. Moreover, the relatively small size and light weight of the saddle holder 10 make it convenient to pack and transport.

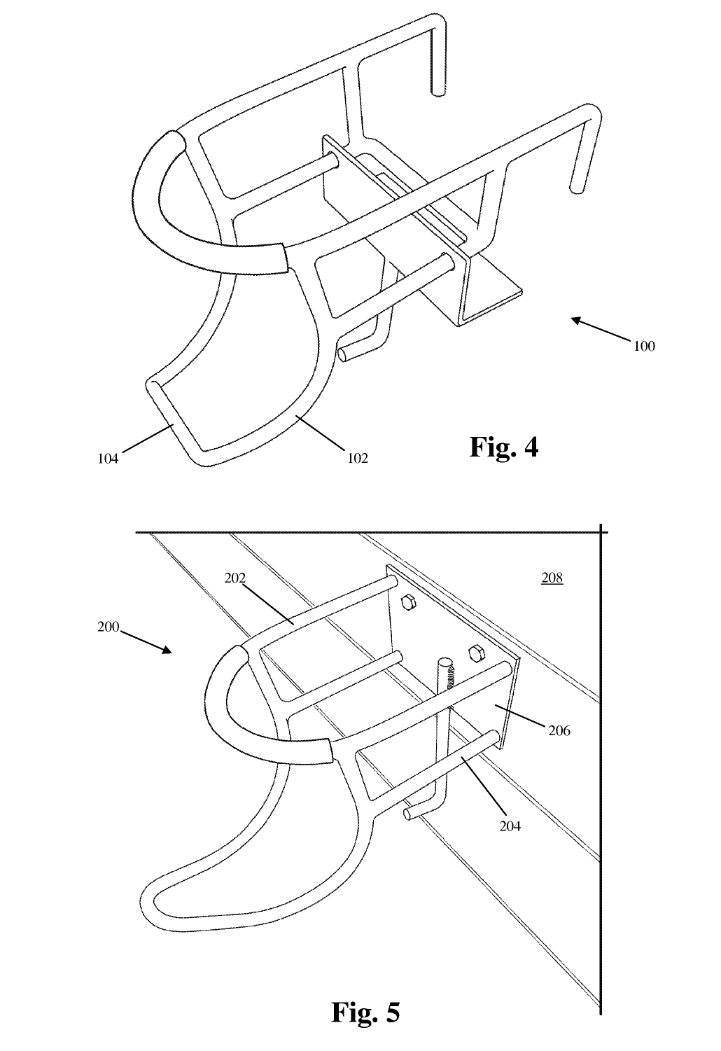

Referring to FIG. 4, an alternative embodiment 100 of the saddle holder 10 is contemplated wherein the fulcrum bracket 102 is formed with a substantially flat forward edge 104 for accommodating the swell of a treeless saddle in a manner that will be understood by those skilled in the art. Referring to FIG. 5, another embodiment 200 of the saddle holder 10 is contemplated wherein the mounting arms 14 and 16 described above are omitted and wherein the rear of the saddle horn retainer 202 and the rear of the stop bracket 204 terminate in a vertically-oriented mounting plate 206. The mounting plate 206 can be affixed to a stall 208 or other support structure, such as with conventional fasteners, adhesives, or welds, for permanently mounting the saddle holder 200 at a desired location.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for holding a saddle comprising:
(a) a saddle horn retainer defining a saddle horn pass-through for accepting a saddle horn;
(b) a fulcrum bracket extending from a bottom of the saddle horn retainer for supporting the saddle; and
(c) means for mounting the apparatus to a support structure.

2. The apparatus for holding a saddle in accordance with claim 1, further comprising an adjustment bracket slidably mounted to the stop bracket, wherein the adjustment bracket is movable between a forward position, wherein a rear edge of the adjustment bracket does not extend beyond a rear terminus of the stop bracket, and a rear position, wherein the rear edge of the adjustment bracket does extend beyond a rear terminus of the stop bracket.

3. The apparatus for holding a saddle in accordance with claim 1, further comprising a bridle hook extending from the adjustment bracket for holding a bridle and reigns.

4. The apparatus for holding a saddle in accordance with claim 1, wherein the saddle horn retainer is a U-shaped member.

5. The apparatus for holding a saddle in accordance with claim 1, wherein the fulcrum bracket defines a recess for accommodating a contour of a forward swell of the saddle.

6. The apparatus for holding a saddle in accordance with claim 1, wherein a front portion of the saddle horn retainer is covered with a resilient material.

7. The apparatus for holding a saddle in accordance with claim 6, wherein the resilient material is selected from a group consisting of plastic, rubber, foam, and leather.

8. The apparatus for holding a saddle in accordance with claim 1, wherein the fulcrum bracket has a flat forward edge for accommodating a treeless saddle.

9. An apparatus for holding a saddle comprising:
(a) a saddle horn retainer defining a saddle horn pass-through for accepting a saddle horn;
(b) a fulcrum bracket extending from a bottom of the saddle horn retainer for supporting the saddle; and
(c) at least one mounting arm extending from the saddle horn retainer and at least one stop bracket extending from behind the fulcrum bracket, wherein the mounting arm and the stop bracket define a gap therebetween for fitting over a top edge of the support structure.

10. The apparatus for holding a saddle in accordance with claim 9, further comprising an adjustment bracket slidably mounted to the stop bracket, wherein the adjustment bracket is movable between a forward position, wherein a rear edge of the adjustment bracket does not extend beyond a rear terminus of the stop bracket, and a rear position, wherein the rear edge of the adjustment bracket does extend beyond a rear terminus of the stop bracket.

11. The apparatus for holding a saddle in accordance with claim 10, further comprising a bridle hook extending from the adjustment bracket for holding a bridle and reigns.

12. The apparatus for holding a saddle in accordance with claim 9, wherein the saddle horn retainer is a U-shaped member.

13. The apparatus for holding a saddle in accordance with claim 9, wherein the fulcrum bracket defines a recess for accommodating a contour of a forward swell of the saddle.

14. The apparatus for holding a saddle in accordance with claim 9, wherein a front portion of the saddle horn retainer is covered with a resilient material.

15. The apparatus for holding a saddle in accordance with claim 14, wherein the resilient material is selected from a group consisting of plastic, rubber, foam, and leather.

16. The apparatus for holding a saddle in accordance with claim 9, wherein the fulcrum bracket has a flat forward edge for accommodating a treeless saddle.

17. An apparatus for holding a saddle comprising:
(a) a saddle horn retainer defining a saddle horn pass-through for accepting a saddle horn;
(b) a fulcrum bracket extending from a bottom of the saddle horn retainer for supporting the saddle; and
(c) a mounting plate extending from a rear of the apparatus that can be affixed to a support structure.

18. The apparatus for holding a saddle in accordance with claim 17, further comprising at least one fastener extending through the mounting plate and into the support structure.

19. The apparatus for holding a saddle in accordance with claim 17, further comprising an adjustment bracket slidably mounted to the stop bracket, wherein the adjustment bracket is movable between a forward position, wherein a rear edge of the adjustment bracket does not extend beyond a rear terminus of the stop bracket, and a rear position, wherein the rear edge of the adjustment bracket does extend beyond a rear terminus of the stop bracket.

20. The apparatus for holding a saddle in accordance with claim 19, further comprising a bridle hook extending from the adjustment bracket for holding a bridle and reigns.

21. The apparatus for holding a saddle in accordance with claim 17, wherein the saddle horn retainer is a U-shaped member.

22. The apparatus for holding a saddle in accordance with claim 17, wherein the fulcrum bracket defines a recess for accommodating a contour of a forward swell of the saddle.

23. The apparatus for holding a saddle in accordance with claim 17, wherein a front portion of the saddle horn retainer is covered with a resilient material.

24. The apparatus for holding a saddle in accordance with claim 23, wherein the resilient material is selected from a group consisting of plastic, rubber, foam, and leather.

25. The apparatus for holding a saddle in accordance with claim 17, wherein the fulcrum bracket has a flat forward edge for accommodating a treeless saddle.

26. An apparatus for holding a saddle comprising:
(a) a U-shaped saddle horn retainer defining a saddle horn pass-through, wherein a horn of the saddle extends through the saddle horn retainer in a vertical orientation;
(b) a fulcrum bracket extending from a bottom of the saddle horn and supporting a swell of the saddle;
(c) at least one mounting arm extending from a rear of the saddle horn retainer and over a top edge of a support structure;
(d) at least one stop bracket extending from behind the fulcrum bracket and defining recess between the stop bracket and the mounting arm for accepting the top edge of the support structure; and
(e) an adjustment bracket slidably mounted to the stop bracket, wherein the adjustment bracket is movable between a forward position, wherein a rear edge of the adjustment bracket does not extend beyond a rear terminus of the stop bracket, and a rear position, wherein the rear edge of the adjustment bracket engages the support structure.

27. The apparatus for holding a saddle in accordance with claim 26, wherein a front portion of the saddle horn retainer is covered with a resilient material.

28. The apparatus for holding a saddle in accordance with claim 26, further comprising a bridle hook extending from the adjustment bracket for holding a bridle and reigns.

29. The apparatus for holding a saddle in accordance with claim 26, wherein the fulcrum bracket has a flat forward edge for accommodating a treeless saddle.
